(19) United States
(12) Patent Application Publication
(10) Pub. No.: US 2015/0017423 A1
(43) Pub. Date: Jan. 15, 2015

(54) METHOD FOR PRODUCING LAMINATE FILM CONTAINING LIQUID CRYSTALLINE COMPOUND HAVING HIGH CRYSTALLINITY

(71) Applicant: FUJIFILM Corporation, Tokyo (JP)

(72) Inventors: Reona IKEDA, Kanagawa (JP); Ichirou AMIMORI, Kanagawa (JP)

(73) Assignee: FUJIFILM CORPORATION, Tokyo (JP)

(21) Appl. No.: 14/495,206

(22) Filed: Sep. 24, 2014

Related U.S. Application Data
(63) Continuation of application No. PCT/JP2013/059185, filed on Mar. 28, 2013.

(30) Foreign Application Priority Data
Mar. 30, 2012 (JP) 2012-082340

(51) Int. Cl. G02F 1/1337

(52) U.S. Cl. CPC G02F 1/133711; G02F 1/133788
USPC 428/323; 427/162; 427/508; 428/336; 428/522

(57) ABSTRACT

The present invention provides a method for producing a laminate film comprising forming a layer by curing a liquid crystalline composition containing a liquid crystalline compound that has a polymerizable group and is solid at 25° C. and forming, on the layer, a polymer layer from a composition containing a polymer, the liquid crystalline compound migrating into the polymer layer after forming the polymer layer until the compound becomes 0.1% by mass to 30% by mass relative to the solid content mass of the polymer layer, wherein the method includes selecting the liquid crystalline compound and the polymer from combinations having a heat of crystallization of a mixture obtained by mixing the two at a mass ratio of 9:10, of 0.75 J/g or less. White cloudiness along with crystallization of the liquid crystalline compound is not generated easily in the method of the present invention.

### CROSS-REFERENCE TO RELATED APPLICATIONS

This application is a continuation of PCT/JP2013/059185, which claims priority to Japanese Patent Application No. 2012-082340 filed on Mar. 30, 2012, the entire contents of which are incorporated herein by reference.

### TECHNICAL FIELD

The present invention relates to a method for producing a laminate film containing a liquid crystalline compound having high crystallinity. More specifically, the present invention relates to a method that can suppress crystallization of the liquid crystalline compound, in a method for producing a laminate film including the formation of a polymer layer on a layer formed of a composition containing a liquid crystalline compound having high crystallinity.

### BACKGROUND ART

A layer formed by curing a composition containing a liquid crystalline compound has optical anisotropy derived from an alignment state of liquid crystalline molecules. By further laminating a polymer layer on an optically-anisotoropic layer thus formed, various laminate films can be provided.

When a composition for manufacturing a polymer layer is applied onto the optically-anisotoropic layer to form the above-mentioned laminated film, the liquid crystalline compound sometimes migrates into the polymer layer and separates out as a crystal to thereby generate white cloudiness. As a measure for avoiding the crystallization of the liquid crystalline compound, as is seen in Patent Literatures 1-5, modification of the structure of a compound having high crystallinity has conventionally been examined. The suppression of crystallization by structural modification is effective for suppressing a crystallization for about several hours in a production process, such as the hours in applying a solution. However, it does not have a crystallization suppressing effect for a long period of storing a product after the application of a solution for 24 hours or longer. Furthermore, even when a liquid crystalline compound has a structure that exerts the crystallization suppressing effect when being used alone, the crystallinity thereof may change to thereby lose the crystallization suppressing effect when a polymer coexists. Accordingly, in a combination with various polymer layers, modification of the structure of a liquid crystalline compound so as not to crystallize even when the compound migrates into these layers requires tremendous labor in the examination thereof.

### CITATION LIST

### Patent Literature

[Patent Literature 1] Japanese Patent Application Laid-Open No. 2005-272560

[Patent Literature 2] WO 2008/026482

[Patent Literature 3] Japanese Patent Application Laid-Open No. 2003-192645

[Patent Literature 4] Japanese Patent Application Laid-Open No. 7-41758

[Patent Literature 5] Japanese Patent Application Laid-Open No. 11-288110

### SUMMARY OF INVENTION

An object of the present invention is, as a method for producing a laminate film including forming a polymer layer on a layer formed of a liquid crystalline composition containing a liquid crystalline compound having high crystallinity, to provide a production method by which white cloudiness along with crystallization of the liquid crystalline compound is not generated easily.

The present inventors have focused on the fact that that ease of crystallization of a liquid crystalline compound depends not only on the crystallinity of a liquid crystalline compound but also on a polymer constituting a polymer layer to be laminated, and have tried to find an indicator of whether the crystallization is generated or not from a parameter in which both are involved. As the result, the inventors have found that there is a correlation between heat of crystallization of a mixture of the two and the generation of crystallization, and have completed the present invention.

The present invention thus provides (1)-(13) described below.

(1) A method for producing a laminate film including forming a layer by curing a liquid crystalline composition containing a liquid crystalline compound that has a polymerizable group and is solid at 25° C. and forming, on the layer, a polymer layer from a composition containing a polymer, the liquid crystalline compound migrating into the polymer layer after forming the polymer layer until the compound becomes 0.1% by mass to 30% by mass relative to the solid content mass of the polymer layer, wherein the method includes selecting the liquid crystalline compound and the polymer from combinations having a heat of crystallization of the mixture obtained by mixing the two at a mass ratio of 9:10, of 0.75 J/g or less.

(2) The production method according to (1), wherein the composition containing a polymer is applied directly on a layer formed by curing the liquid crystalline composition.

(3) The production method according to (1) or (2), wherein the liquid crystalline compound migrates into the polymer layer after forming the polymer layer until the compound becomes 1% by mass to 20% by mass relative to the solid content mass of the polymer layer.

(4) The production method according to any one of (1) to (3), wherein the curing is performed by a polymerization reaction by light irradiation.

(5) The production method according to any one of (1) to (4), wherein the composition containing a polymer is applied as a solution of a solvent selected from an alkyl halide, an ester, a ketone, an alcohol, a glycol ether or a mixture thereof.

(6) The production method according to (5), wherein the composition containing a polymer is applied as a solution of a solvent selected from acetone, methyl ethyl ketone, methyl isobutyl ketone, cyclohexanone, methanol, ethanol, isopropanol, butanol, propylene glycol monomethyl ether, dipropylene glycol monomethyl ether or a mixture thereof.

(7) A laminate film produced by the production method according to any one of (1) to (6).

(8) A laminate film including a layer formed of a liquid crystalline composition containing a liquid crystalline compound having a polymerizable group and a polymer layer formed of a composition containing a polymer in this order, wherein the liquid crystalline compound is contained in the polymer layer in an amount of 0.1% by mass to 30% by mass relative to solid content mass of the polymer layer; the liquid crystalline compound is a compound that is solid at 25° C.; and heat of crystallization of a mixture obtained by mixing the liquid crystalline compound and the polymer at a mass ratio of 9:10 is 0.75 J/g or less.

(9) The laminate film according to (7) or (8) wherein the polymer layer is an optically isotropic layer.

(10) The laminate film according to any one of (7) to (9), wherein the liquid crystalline compound is a rod-like liquid crystalline compound having two polymerizable groups; and the polymer is polymethyl (meth)acrylate, a copolymer of (meth)acrylic acid and (meth)acrylic acid ester, polyester, polyurethane, polystyrene, polyvinyl alcohol, ethylene-vinyl acetate copolymer, polyvinyl chloride or a cellulose derivative.

(11) The laminate film according to any one of (7) to (10), wherein the polymer has a polar group or a hydrophilic group on a side chain.

(12) The laminate film according to (11), wherein the polar group or the hydrophilic group is hydroxyl group or carboxyl group.

(13) The laminate film according to any one of (7) to (12), wherein thickness of the polymer layer is 10 μm or less.

### Effect of the Invention

By the present invention, a method for producing a laminate film that includes forming a polymer layer on a layer formed of a liquid crystalline composition containing a liquid crystalline compound having high crystallinity is provided, the method being capable of producing a laminate film by which white cloudiness caused by crystallization of the liquid crystalline compound is not generated easily.

### MODES OF CARRYING OUT INVENTION

Hereinafter, the present invention will be explained in detail.

In the present description, “to” is used in the sense that numeral values described before and after thereof are included as the lower limit value and the upper limit value.

In the description, Re represents retardation (phase difference). Re can be measured using a spectrum phase difference method, in which a transmission or reflection optical spectrum is converted to phase difference by using a method described in Journal of Optical Society of America, vol. 39, p. 791-794 (1949) or Japanese Patent Application Laid-Open No. 2008-256590. The measurement method described in the literature is a method using a transmission spectrum, but particularly in the case of a reflection spectrum, since light passes through an optically-anisotoropic layer twice, a half of the phase difference calculated from a reflection spectrum can be defined as the phase difference of the optically-anisotoropic layer. The retardation (Re) denotes a frontal retardation unless otherwise designated particularly. Re(λ) is one obtained by using light having a wavelength of λ nm as a measurement light. The Re in the description means one measured at a wavelength of 611±5 nm, 545±5 nm and 435±5 nm for R, G and B, respectively, and if there is no description about color particularly, the Re means one measured at a wavelength of 545±5 nm.

In the description, “substantially” for an angle means that an error from a strict angle is in the range of less than ±5°. Furthermore, an error from a strict angle is preferably less than 4°, more preferably less than 3°. “Substantially” for retardation means that the retardation gives a difference that is ±5% or less. Moreover, the fact that retardation is substantially 0 means that the retardation is 5 nm or less. In addition, a measurement wavelength of a refractive index denotes arbitrary wavelength in a visible light region, unless otherwise stated particularly. In the description, “visible light” means light having a wavelength of 400 to 700 nm.

In the description, “mass of solid content” means mass of a remaining part after a volatile part has volatilized. (Meth)acrylic acid is used in the sense that either acrylic acid or methacrylic acid or both of acrylic acid and methacrylic acid are included, and (meth)acrylate is used in the sense that either acrylate or methacrylate or both of acrylate and methacrylate are included.

### [Method for Producing a Laminate Film]

The laminate film that can be produced by the production method of the present invention has a support, a layer formed of a liquid crystalline composition containing a liquid crystalline compound having a polymerizable group, and a polymer layer formed of a composition containing a polymer in this order. The present invention provides a method capable of producing a laminate film by which white cloudiness derived from crystallization of the liquid crystalline compound is not generated easily, in particular, in the case where the liquid crystalline compound is a compound having high crystallinity, specifically, in the case where the liquid crystalline compound is a compound that is solid at 25° C.

Between the layer formed of the liquid crystalline composition and the polymer layer, another layer may exists, but typically, the polymer layer is formed of a layer obtained by applying directly a composition containing a polymer onto the layer formed of the liquid crystalline composition. According to the production method of the present invention, in the laminate film, even when the liquid crystalline compound exists in an amount of 0.1% by mass to 30% by mass relative to the solid content mass of the polymer layer, for example, in an amount of 1% by mass to 20% by mass, crystallization of the liquid crystalline compound in the polymer layer can be suppressed. The liquid crystalline compound migrates into the polymer layer, for example, in the applying and laminating processes of the polymer layer.

The present inventor has found that white cloudiness is not generated in the produced laminate film by selecting the liquid crystalline compound and the polymer so that a heat of crystallization of the mixture obtained by mixing the two at a mass ratio of 9:10 (mass of liquid crystalline compound: mass of polymer) is 0.75 J/g or less. Each of the liquid crystalline compound and the polymer may be a mixture, and, in the case, the liquid crystalline compound and the polymer may be mixed at the above-described mass ratio on the basis of the mass of the liquid crystalline compound as a mixture and the mass of the polymer as a mixture, respectively.

As to the mixing of a liquid crystalline compound and a polymer when the heat of crystallization is to be obtained, a measure is not limited as long as both can be mixed uniformly. As a mixture of a liquid crystalline compound and a polymer, a mixture obtained, for example, by dissolving the liquid crystalline compound and the polymer in a solvent, and after that, drying the solution may be used. As the solvent in this case, a solvent that completely dissolves both is preferable, and the kind thereof is not particularly limited. Specific example thereof include acetone, methyl ethyl ketone, methyl isobutyl ketone, cyclohexanone, methanol, ethanol, isopropanol, butanol, propylene glycol monomethyl ether, dipropylene glycol monomethyl ether and a mixture thereof.

A method for obtaining the heat of crystallization is not particularly limited, and, for example, the heat may be determined by a value measured using differential scanning calorimetry (DSC). Measurement of the heat of crystallization is performed preferably in a temperature-lowering process in DSC. The heat of crystallization is preferably 0.50 J/g or less, more preferably 0.25 J/g or less.

### [Liquid Crystalline Compound Having Polymerizable Group]

In the production method of the present invention, a compound having a polymerizable group is used as the liquid crystalline compound.

In addition, as the liquid crystalline compound for forming the laminate film, a compound that is solid at 25° C. is used. As the compound, for example, a compound that exhibits a crystallization peak of 25° C. or higher in a temperature-lowering process when DSC is performed as a single article may be used. The liquid crystalline compound may be a mixture, and in that case, each of liquid crystalline compounds constituting the mixture is solid at 25° C.

The molecular weight of the liquid crystalline compound in the liquid crystalline composition before a curing process, usually, may be in the range of 150 to 100,000. The molecular weight is in the range of preferably 340 to 50,000, more preferably 480 to 3,000.

A liquid crystalline compound is, generally, classified into a rod-like type and a discotic type on the basis of the shape thereof. Furthermore, each includes a low-molecular type and a high-molecular type. A polymer generally denotes one having a polymerization degree of 100 or more (Polymer Physics, Phase Transition Dynamics, Masao Doi, p 2, Iwanami Shoten, 1992). In the present invention, any of the liquid crystalline compounds may be used, but the use of a rod-like liquid crystalline compound is preferable.

In the description, when a layer formed of a composition containing a liquid crystalline compound is described, a compound having liquid crystallinity is not required to be contained in the formed layer. The layer may be, for example, a layer: containing a compound originating in the low-molecular liquid crystalline compound having a group that reacts through heat, light or the like, and as the result, carrying out polymerization or cross-linking by a reaction through heat, light or the like to thereby be converted to a high-molecular-weight compound and thereby have lost liquid crystal properties. As the liquid crystalline compound, two or more kinds of rod-like liquid crystalline compounds, two or more kinds of discotic liquid crystalline compounds, or a mixture of a rod-like liquid crystalline compound and a discotic liquid crystalline compound may be used. The liquid crystalline compound has preferably two or more polymerizable groups. In the case of a mixture of two or more kinds of liquid crystalline compounds, at least one may have two or more polymerizable groups.

Examples of the polymerizable group includes a vinyl group, (meth)acrylic group, epoxy group, oxetanyl group, vinyl ether group, hydroxyl group, carboxylic acid group, amino group and the like.

In the case where a liquid crystalline compound has two or more polymerizable groups, all of them may be the same, any of two or more groups may be the same, or may be different from one another. A liquid crystalline compound having two or more kinds of polymerizable groups as the two or more polymerizable groups may also be used. Production of a laminate exhibiting a pattern-like optical anisotropy is also possible by using such a liquid crystalline compound and cross-linking two or more kinds of polymerizable groups in a stepwise manner. For example, a reaction can be controlled through the use of a combination of a radical polymerizable group and a cationic polymerizable group, according to reaction conditions such as a kind or the like of an initiator to be used. The reactivity is easily controlled by combination of a vinyl group or a (meth)acrylic group as the radical polymerizable group, and an epoxy group, an oxetanyl group or a vinyl ether group as the cationic polymerizable group. Hereinafter, examples of the polymerizable groups are shown.

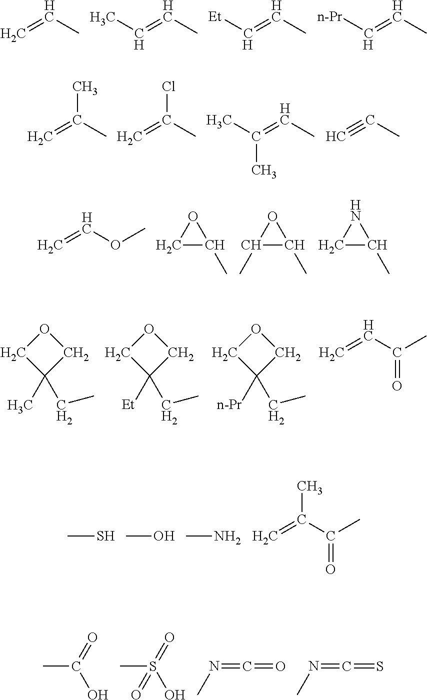

As the rod-like liquid crystalline compound, azomethines, azoxys, cyanobiphenyls, cyanophenylesters, benzoic esters, cyclohexane carboxylic acid phenylesters, cyanophenylcyclohexanes, cyano-substituted phenylpyrimidines, alkoxy-substituted phenylpyrimidines, phenyldioxanes, tolans and alkenylcyclohexylbenzonitriles are used preferably. In addition to low-molecular liquid crystalline compounds as described above, high-molecular liquid crystalline compounds can also be used. The high-molecular liquid crystalline compound is a high-molecular compound obtained from polymerization of a low-molecular rod-like liquid crystalline compound having a reactive group. Examples of the rod-like liquid crystalline compound include those described in Japanese Patent Application Laid-Open No. 2008-281989, US Patent No. 2008/0259268, Published Japanese translation of PCT patent application Nos. 11-513019 (International Publication WO 97/00600) or 2006-526165.

Hereinafter, specific examples of rod-like liquid crystalline compounds that are solid at 25° C. are shown, but the present invention is not limited to these. The compounds shown below can be synthesized by referring to the method described in Published Japanese translation of PCT patent application No. 11-513019 (WO 97/00600).

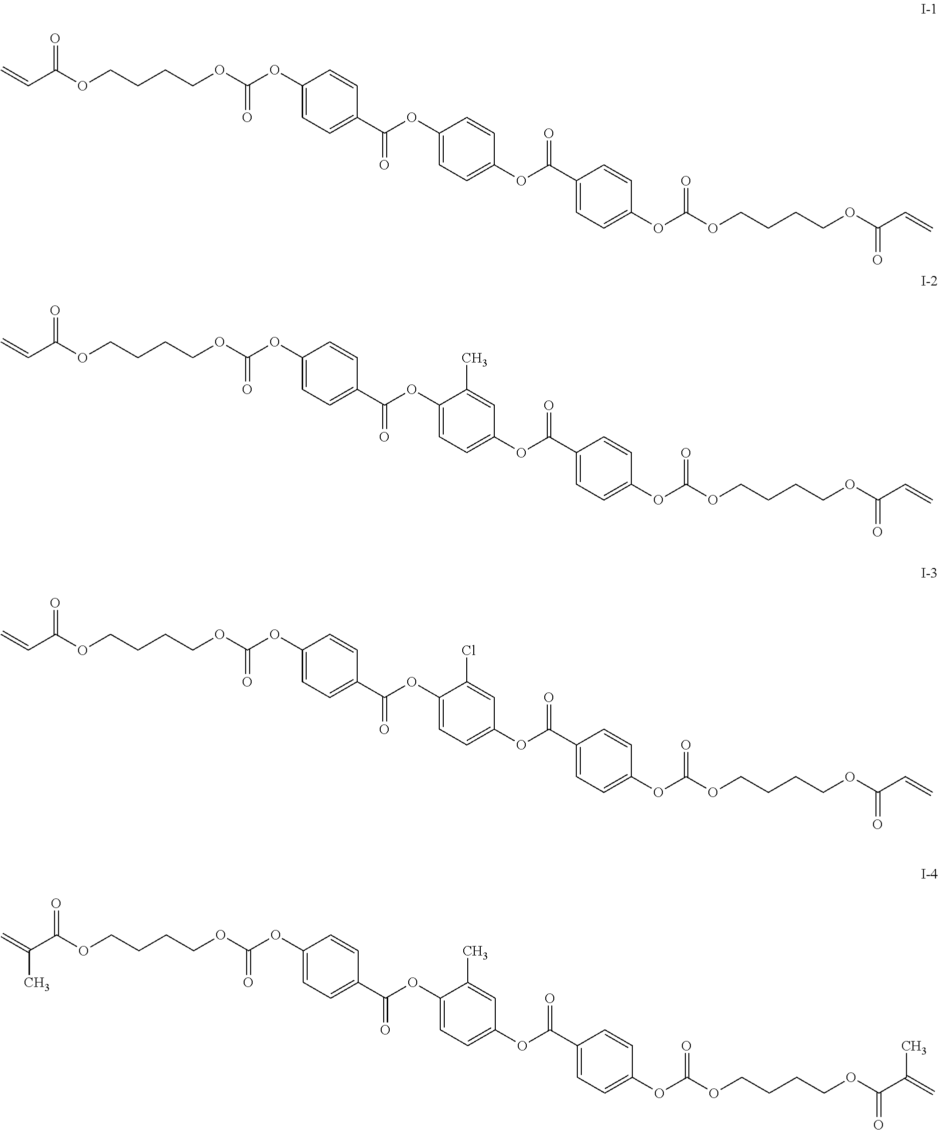

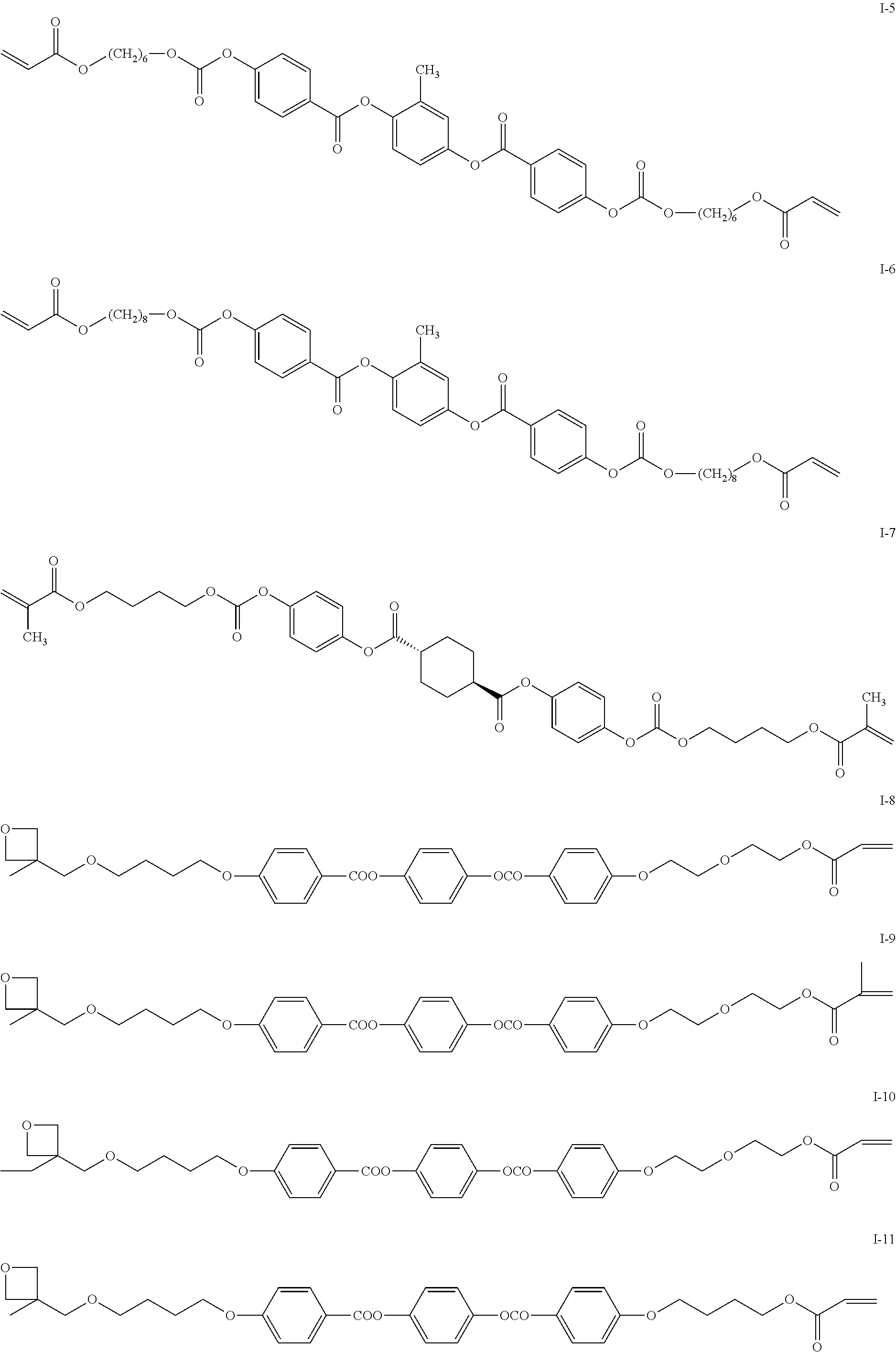

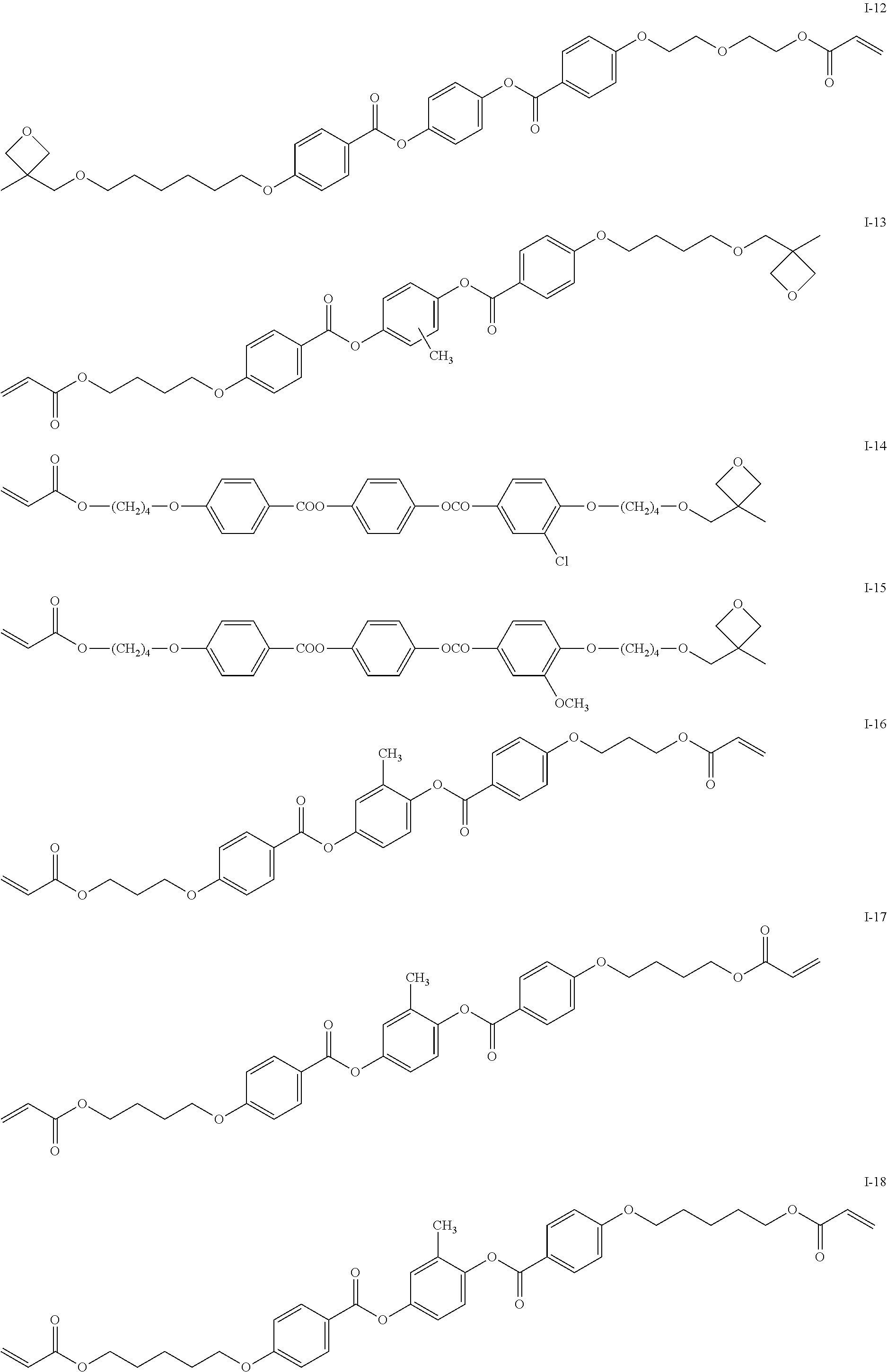

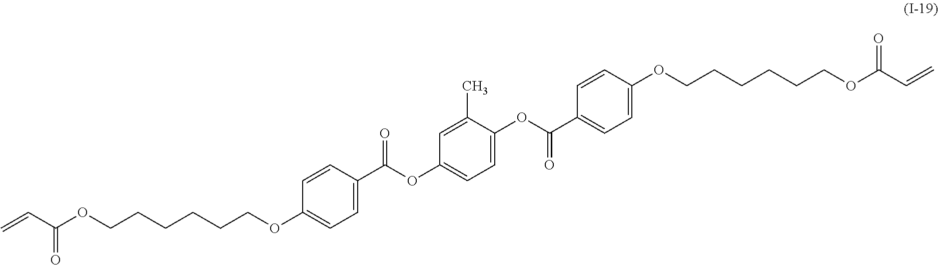 [SMILES: C=CC(=O)OCCCCCCOc1ccc(C(=O)Oc2ccc(OC(=O)c3ccc(OCCCCCCOC(=O)C=C)cc3)c(C)c2)cc1]

As the liquid crystalline compound, a discotic liquid crystalline compound can also be used. Examples of the discotic liquid crystalline compounds include benzene derivatives described in the study report of C. Destrade et al., Mol. Cryst. vol. 71, p 111 (1981); truxene derivatives described in the study report of C. Destrade et al., Mol. Cryst. vol. 122, p 141 (1985) or Physics Letters A, vol. 78, p 82 (1990); cyclohexane derivatives described in the study report of B. Kohne et al., Angew. Chem. vol. 96, p 70 (1984); and azacrown-based or phenylacetylene-based macrocycles described in the study report of J. M. Lehn et al., J. Chem. Commun. p 1794 (1985), or the study report of J. Zhang et al., J. Am. Chem. Soc. vol. 116, p 2655 (1994). The discotic liquid crystalline compounds generally have a structure having these as a discotic mother nucleus at the molecular center and a structure in which a group such as a linear alkyl group or an alkoxy group, or a substituted benzoyloxy group is substituted radially, exhibit liquid crystallinity, and include those that are generally referred to as a discotic liquid crystal. However, when such an aggregate of molecules is aligned uniformly, a negative uniaxial property is exhibited, but the description is not limiting. Examples of the discotic liquid crystalline compounds include compounds described in Japanese Patent Application Laid-Open No. 2008-281989, paragraphs [0061] to [0075].

It is sufficient that the liquid crystalline compound is contained in preferably 30% by mass to 99.9% by mass, more preferably 50% by mass to 99.9% by mass, and further more preferably 70% by mass to 99.9% by mass relative to the total solid content mass of the liquid crystalline composition.

A layer can be produced by curing a liquid crystalline composition containing a liquid crystalline compound having a polymerizable group. For example, a layer can be produced by applying a liquid crystalline composition having a polymerizable group in a solution state, onto a support or an alignment layer or the like provided on a support, subsequently by drying the applied layer to thereby form a liquid crystal phase and, after that, by polymerizing and fixing the liquid crystalline compound through heating or light irradiation. The thickness of the layer to be produced is, for example, 0.1 to 20 μm or 0.5 to 10 μm.

The layer thus produced serves as, usually, an optically-anisotoropic layer having optical anisotropy.

### [Optically-Anisotoropic Layer]

An optically-anisotoropic layer is a layer that has at least one incidence direction in which retardation is substantially not 0 when retardation is measured, that is, a layer that has not isotropic optical characteristics. The optically-anisotoropic layer may be a patterned optically-anisotoropic layer having pattern-like birefringent properties.

The retardation of the optically-anisotoropic layer is preferably 5 nm or more at 20° C., preferably 10 nm or more to 10000 nm or less, most preferably 20 nm or more to 2000 nm or less.

The liquid crystalline compound may be fixed in any alignment state of horizontal alignment, vertical alignment, tilt alignment and twist alignment. The “horizontal alignment” in the description means that a long axis of a molecule is parallel to the horizontal plane of a support in the case of a rod-like liquid crystal, and that the disc plane of a core of a discotic liquid crystalline compound is parallel to the horizontal plane of a support in the case of a discotic liquid crystal. However, strict parallelism is not required, and in the description, the horizontal alignment means an alignment of less than 10 degrees relative to the horizontal plane. As the optically-anisotoropic layer, it is preferable to contain a rod-like liquid crystal compound fixed in a horizontally aligned state.

In an optically-anisotoropic layer formed by curing a liquid crystalline composition, that is, formed by aligning and fixing a composition containing a liquid crystalline compound, a polymerizable monomer may be added in order to accelerate the cross-linking of the liquid crystalline compound.

For example, a monomer or an oligomer that has two or more ethylenically unsaturated double bonds and is addition-polymerized by light irradiation can be used.

An example of the monomer or oligomer includes a compound having at least one addition-polymerizable ethylenically unsaturated group in the molecule. Examples of the monomers or oligomers include monofunctional acrylates and monofunctional methacrylates such as polyethylene glycol mono(meth)acrylate, polypropylene glycol mono(meth)acrylate and phenoxyethyl (meth)acrylate; and polyfunctional acrylate and polyfunctional methacrylate such as polyethylene glycol di(meth)acrylate, polypropylene glycol di(meth)acrylate, trimethylolethane triacrylate, trimethylolpropane tri(meth)acrylate, trimethylolpropane diacrylate, neopentyl glycol di(meth)acrylate, pentaerythritol tetra(meth)acrylate, pentaerythritol tri(meth)acrylate, dipentaerythritol hexa(meth)acrylate, dipentaerythritol penta(meth)acrylate, hexanediol di(meth)acrylate, trimethylolpropane tri(acryloyloxypropyl)ether, tri(acryloyloxyethyl)isocyanurate, tri(acryloyloxyethyl)cyanurate, glycerin tri(meth)acrylate; and those obtained by adding ethylene oxide or propylene oxide to a polyfunctional alcohol such as trimethylolpropane or glycerin, and after that, by making it into (meth)acrylate.

Furthermore, urethane acrylates described in Japanese Patent Nos. 48-41708, 50-6034 and Japanese Patent Application Laid-Open No. 51-37193; polyester acrylates described in Japanese Patent Application Laid-Open No. 48-64183, Japanese Patent Nos. 49-43191 or 52-30490; and polyfunctional acrylates and methacrylates such as epoxy acrylates that are reaction products of epoxy resin and (meth)acrylic acid can be included.

Among them, trimethylolpropane tri(meth)acrylate, pentaerythritol tetra(meth)acrylate, dipentaerythritol hexa(meth)acrylate and dipentaerythritol penta(meth)acrylate are preferable.

In addition, a “polymerizable compound B” described in Japanese Patent Application Laid-Open No. 11-133600 can also be exemplified as a preferable example. These monomers or oligomers may be used alone, or as a mixture of two or more kinds.

Moreover, a cationic polymerizable monomer can also be used. Examples thereof include an epoxy compound, a vinyl ether compound, an oxetane compound and the like exemplified in Japanese Patent Application Laid-Open Nos. 6-9714, 2001-31892, 2001-40068, 2001-55507, 2001-310938, 2001-310937 or 2001-220526.

Examples of the epoxy compounds include an aromatic epoxide, an alicyclic epoxide and an aliphatic epoxide and the like, which are described below. Examples of the aromatic epoxides include bisphenol A, di- or polyglycidyl ether that is an alkylene oxide adduct thereof, hydrogenated bisphenol A or di- or polyglycidyl ether that is an alkylene oxide adduct thereof, novolac type epoxy resin and the like. Examples of the alkylene oxides include ethylene oxide, propylene oxide and the like.

Examples of the alicyclic epoxides include compounds containing cyclohexene oxide or cyclopentene oxide obtained by epoxidating a compound having at least one cycloalkane ring such as a cyclohexene or cyclopentene ring, with an appropriate oxidizing agent such as hydrogen peroxide or peracid. Preferable examples of the aliphatic epoxides include di- or polyglycidyl ether of aliphatic polyvalent alcohol or an alkylene oxide adduct thereof and the like, and typical examples thereof include diglycidyl ether of alkylene glycol such as diglycidyl ether of ethylene glycol, diglycidyl ether of propylene glycol, or diglycidyl ether of 1,6-hexanediol; polyglycidyl ether of polyvalent alcohol such as di- or triglycidyl ether of glycerin or an alkylene oxide adduct thereof; diglycidyl ether of polyalkylene glycol such as diglycidyl ether of polyethylene glycol or an alkylene oxide adduct thereof, or diglycidyl ether of polypropylene glycol or an alkylene oxide adduct thereof or the like. Examples of the alkylene oxide include ethylene oxide, propylene oxide and the like.

Furthermore, in the liquid crystalline composition, a monofunctional or bifunctional oxetane monomer can also be used as a cationic polymerizable monomer. For example, 3-ethyl-3-hidroxymethyl oxetane (trade name OXT101 etc., manufactured by Toagosei Co., Ltd.), 1,4-bis[(3-ethyl-3-oxetanyl)methoxymethyl]benzene (trade name OXT121 etc.), 3-ethyl-3-(phenoxymethyl)oxetane (trade name OXT211 etc.), di(1-ethyl-3-oxetanyl)methylether (trade name OXT221 etc.), 3-ethyl-3-(2-ethyl-hexyloxymethyl)oxetane (trade name OXT212 etc.) and the like can preferably be used. In particular, compounds such as 3-ethyl-3-hidroxymethyl oxetane, 3-ethyl-3-(phenoxymethyl)oxetane, di(1-ethyl-3-oxetanyl)methyl ether, all of the well-known monofunctional or bifunctional oxetane compounds described in Japanese Patent Application Laid-Open Nos. 2001-220526 and 2001-310937 can be used.

### [Solvent]

As a solvent used for preparing a coating liquid when the liquid crystalline composition is applied, for example, on the surface of a support, an alignment layer to be described later or the like as a coating liquid, an organic solvent is used preferably. Examples of the organic solvents include an amide (such as N,N-dimethylformamide), a sulfoxide (such as dimethylsulfoxide), a heterocyclic compound (such as pyridine), a hydrocarbon (such as benzene and hexane), an alkyl halide (such as chloroform and dichloromethane), an ester (such as methyl acetate and butyl acetate), a ketone (such as acetone, methyl ethyl ketone, methyl isobutyl ketone and cyclohexanone), an ether (such as tetrahydrofuran and 1,2-dimethoxyethane), an alcohol (such as methanol and ethanol), an ethylene glycol (such as propylene glycol monomethyl ether and dipropylene glycol monomethyl ether). Furthermore, two or more kinds of solvents may be mixed and used. Among the above solvents, an alkyl halide, an ester, a ketone, an alcohol, an ethylene glycol and a mixed solvent thereof are preferable.

### [Fixation of Alignment]

The fixation of alignment of the liquid crystalline compound is preferably performed by a cross-linking reaction of a polymerizable group of the liquid crystalline compound, more preferably by a polymerization reaction of a polymerizable group. The polymerization reaction includes a thermal polymerization reaction that uses a thermal polymerization initiator and a photopolymerization reaction that uses a photopolymerization initiator, and the photopolymerization reaction is more preferable. As the photopolymerization reaction, either radical polymerization or cationic polymerization can be employed. Examples of radical photopolymerization initiators include an α-carbonyl compound (described in each of U.S. Pat. Nos. 2,367,661 and 2,367,670), acyloin ether (described in U.S. Pat. No. 2,448,828), an α-hydrocarbon-substituted aromatic acyloin compound (described in U.S. Pat. No. 2,722,512), polynuclear quinone compounds (described in each of U.S. Pat. Nos. 3,046,127 and 2,951,758), a combination of triarylimidazole dimer and p-aminophenylketone (described in U.S. Pat. No. 3,549,367), acridine and phenazine compounds (described in Japanese Patent Application Laid-Open No. (Shyowa) 60-105667, U.S. Pat. No. 4,239,850) and oxadiazole compounds (described in U.S. Pat. No. 4,212,970). Examples of cationic photopolymerization initiators include organic sulfonium salt-based, iodonium salt-based and phosphonium salt-based compounds and the like, and an organic sulfonium salt-based compound is preferable, and triphenylsulfonium salt is particularly preferable. As a counter ion of these compounds, hexafluoroantimonate, hexafluorophosphate or the like is preferably used.

The use amount of the photopolymerization initiator is preferably 0.01 to 20% by mass, and more preferably 0.5 to 5% by mass of a solid content of a coating liquid. Ultraviolet rays are preferably used for light irradiation for polymerizing the liquid crystalline compound. Irradiation energy is preferably 10 mJ/cm² to 10 J/cm², further preferably 25 to 1000 mJ/cm². Luminous intensity is preferably 10 to 2000 mW/cm², more preferably 20 to 1500 mW/cm², and further more preferably 40 to 1000 mW/cm². As an irradiation wavelength, it is preferable to have a peak in 250 to 450 nm, and it is further preferable to have a peak in 300 to 410 nm. Light irradiation may be performed under an atmosphere of inert gas such as nitrogen or under a heated condition in order to accelerate the photopolymerization reaction.

### [Horizontal Alignment Agent]

By incorporating, in the liquid crystalline composition, at least one kind of fluorine-containing homopolymers or copolymers using a compound represented by general formulae (1) to (3) and a monomer of a general formula (4) described in Japanese Patent Application Laid-Open No. 2009-69793, paragraphs [0098] to [0105], molecules of the liquid crystalline compound can be aligned substantially horizontally. When the liquid crystalline compound is to be aligned horizontally, the tilt angle thereof is preferably 0 to 5 degrees, more preferably 0 to 3 degrees, further more preferably 0 to 2 degrees, and most preferably 0 to 1 degree.

As an addition amount of the horizontal alignment agent, 0.01 to 20% by mass of the mass of the liquid crystalline compound is preferable, 0.01 to 10% by mass is more preferable, and 0.02 to 1% by mass is particularly preferable. The compound represented by general formulae (1) to (4) described in Japanese Patent Application Laid-Open No. 2009-69793, paragraphs [0098] to [0105] may be used alone, or in combination of two or more kinds.

### [Polymer Layer Formed of Composition Containing Polymer]

Examples of the polymer layer formed of a composition containing a polymer include an alignment layer for providing an additional optically-anisotoropic layer, a protective layer of an optically-anisotoropic layer, a scattering layer that controls scattering of transmitted light, a hard coat layer preventing scratch of a lower layer, an antistatic layer preventing adhesion of dust due to charging, a printing coating layer to be a foundation of printing, a printing layer that gives decorativeness, and the like. The polymer layer may be a layer that contains a polymerization initiator for causing an unreacted polymerizable group in the optically-anisotoropic layer to react.

As aforementioned, in the polymer layer in the laminate film of the present invention, the liquid crystalline compound is contained in an amount of 0.1% by mass to 30% by mass. The content of the liquid crystalline compound is confirmed by the amount of the liquid crystalline compound existing in a layer after curing the layer. The content of the liquid crystalline compound can be confirmed by cutting the polymer layer and performing IR measurement of powder. In the polymer layer, the liquid crystalline compound may preferably be contained in an amount of 1% by mass to 20% by mass.

The thickness of the polymer layer is not particularly limited, and may be about 100 μm or less, 50 μm or less, 15 μm or less or 10 μm or less, and may be about 0.1 μm or more, 0.3 μm or more or 0.5 μm or more.

### [Polymer]

The polymer is not particularly limited, and includes polymethyl (meth)acrylate, copolymers of (meth)acrylic acid and various esters of (meth)acrylic acid, polystyrene, copolymers of styrene and (meth)acrylic acid or various (meth)acrylic acid esters, polyvinyl alcohol, polyvinyl toluene, copolymers of vinyl toluene and (meth)acrylic acid or various (meth)acrylic acid esters, styrene/vinyl toluene copolymer, polyvinyl chloride, polyvinylidene chloride, polyvinyl acetate, vinyl acetate/ethylene copolymer, vinyl acetate/vinyl chloride copolymer, polyester, polyimide, polyurethane, polystyrene, cellulose derivatives (such as carboxymethylcellulose), polyethylene, polypropylene, polycarbonate, and the like. Preferable examples include copolymer of methyl(meth)acrylate and (meth)acrylic acid, copolymer of allyl(meth)acrylate and (meth)acrylic acid, multicomponent copolymers of benzyl(meth)acrylate, (meth)acrylic acid and another monomer. These polymers may be used alone, or in combination of a plurality of kinds.

The molecular weight of the polymer is not particularly limited, and, usually, may be in the range of 3,000 to 150,000 in weight average molecular weight. The molecular weight may be in the range of preferably 4,000 to 80,000, more preferably 5,000 to 30,000.

The content of the polymer relative to the total solid content in a composition containing the polymer is generally 20 to 99% by mass, preferably 40 to 99% by mass, more preferably 60 to 98% by mass.

The polymer preferably also has a polar group or a hydrophilic group on a side chain. This is for enhancing coating properties and adhesiveness when further laminating another functional layer (such as a printing layer) on the polymer layer. The polar group or hydrophilic group is not particularly limited, and examples thereof include amino group, hydroxyl group, sulfonic acid group, carboxyl group and the like, among which hydroxyl group and carboxyl group are preferable.

### [Combination of Polymer and Liquid Crystalline Compound]

For the combination of a polymer and a liquid crystalline compound having a heat of crystallization of the mixture obtained by mixing the two at a mass ratio of 9:10 of 0.75 J/g or less, for example, the liquid crystalline compound can be selected from among rod-like liquid crystalline compounds having two or more polymerizable groups and the polymer can be selected from among polymethyl (meth)acrylate, copolymers of (meth)acrylic acid and various esters thereof, polyester, polyurethane, polystyrene, polyvinyl alcohol, ethylene-vinyl acetate copolymer, polyvinyl chloride and cellulose derivatives.

The composition containing the polymer may be applied directly onto a layer formed of the liquid crystalline composition to form a polymer layer. The composition containing the polymer is preferably applied as a solution, then dried to let a solvent volatize, resulting in formation of a layer. The solvent includes an organic solvent. Examples of the organic solvent include an amide (such as N,N-dimethylformamide), a sulfoxide (such as dimethylsulfoxide), a heterocyclic compounds (such as pyridine), a hydrocarbon (such as benzene and hexane), an alkyl halide (such as chloroform and dichloromethane), an ester (such as methyl acetate and butyl acetate), a ketone (such as acetone, methyl ethyl ketone, methyl isobutyl ketone and cyclohexanone), an ether (such as tetrahydrofuran and 1,2-dimethoxyethane), an alcohol (such as methanol and ethanol), ethylene glycol, propylene glycol monomethyl ether, and dipropylene glycol monomethyl ether. Two or more kinds of solvents may be mixed and used. Among the above solvents, an alkyl halide, an ester, a ketone, an alcohol, ethylene glycol and a mixed solvent thereof are preferable.

The polymer layer may be, for example, a photosensitive resin layer. The photosensitive resin layer contains preferably at least one kind of polymer and at least one kind of photopolymerization initiator.

Examples of the polymerization initiator include a thermal polymerization initiator, a photopolymerization initiator or the like, which is used appropriately in accordance with the type of the polymerization. As the photopolymerization initiator, either a radical photopolymerization initiator or a cationic photopolymerization initiator can be used.

The radical photopolymerization initiator includes a vicinal polyketaldonyl compound disclosed in U.S. Pat. No. 2,367,660, an acyloin ether compound described in U.S. Pat. No. 2,448,828, an α-hydrocarbon-substituted aromatic acyloin compound described in U.S. Pat. No. 2,722,512, polynuclear quinone compounds described in U.S. Pat. Nos. 3,046,127 and 2,951,758, a combination of triarylimidazole dimer and p-aminoketone described in U.S. Pat. No. 3,549,367, a benzothiazole compound and a trihalomethyl-s-triazine compound described in Japanese Patent No. 51-48516, a trihalomethyl-triazine compound described in U.S. Pat. No. 4,239,850, a trihalomethyl oxadiazole compound described in U.S. Pat. No. 4,212,976, and the like. In particular, trihalomethyl-s-triazine, trihalomethyl oxadiazole and triarylimidazole dimer are preferable. Furthermore, a preferable example includes a “polymerization initiator C” described in Japanese Patent Application Laid-Open No. 11-133600.

As the cationic photopolymerization initiator, organic sulfonium salt-based, iodonium salt-based, phosphonium salt-based compounds and the like can be exemplified, among which an organic sulfonium salt-based compound is preferable and triphenylsulfonium salt is particularly preferable. As a counter ion of these compounds, hexafluoroantimonate, hexafluorophosphate or the like is preferably used.

Furthermore, the amount of the polymerization initiator is preferably 0.01 to 20% by mass of the solid content of the composition containing the polymer, more preferably 0.2 to 10% by mass.

From the viewpoint of preventing effectively unevenness, an appropriate surfactant is preferably incorporated into the polymer layer. The surfactant that is miscible with the photosensitive resin composition can be used. Preferable examples of surfactants for use in the present invention include, as appropriate ones, surfactants disclosed as the invention in Japanese Patent Application Laid-Open Nos. 2003-337424 [0090]-[0091], 2003-177522 [0092]-[0093], 2003-177523 [0094]-[0095], 2003-177521 [0096]-[0097], 2003-177519 [0098]-[0099], 2003-177520 [0101], 11-133600 [0102]-[0103], and 06-16684. In order to obtain a higher effect, the incorporation of any of a fluorine-containing surfactant, and/or a silicon-based surfactant (a fluorine-containing surfactant, or a silicon-based surfactant, a surfactant containing both a fluorine atom and a silicon atom), or two or more kinds thereof is preferable, and the fluorine-containing surfactant is most preferable. When the fluorine-containing surfactant is used, the number of fluorine atoms in the fluorine-containing substituent of the surfactant is preferably 1 to 38, more preferably 5 to 25, most preferably 7 to 20. A fluorine-containing surfactant in which the number of fluorine atoms is too large is not preferable in that the solubility to an ordinary solvent not containing fluorine is reduced. The fluorine-containing surfactant in which the number of fluorine atoms is too small is not preferable in that the effect of improving unevenness is not obtained.

A particularly preferable example of surfactant include one containing a copolymer formed from monomers represented by a general formula (a) and a general formula (b) below, respectively, and having a mass ratio of general formula (a)/general formula (b) of 20/80 to 60/40.

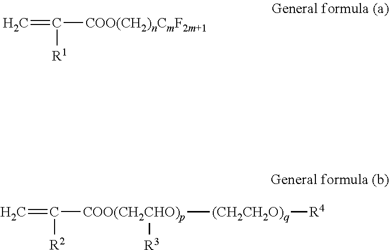

In the formulae, R¹, R² and R³ each independently represents hydrogen atom or a methyl group, R⁴ represents hydrogen atom or an alkyl group having 1 to 5 carbons. n represents an integer of 1 to 18, and m represents an integer of 2 to 14. p and q represent an integer of 0 to 18, respectively, excluding the case where both of p and q are 0 simultaneously.

The monomer represented by the general formula (a) is denoted by monomer (a), and the monomer represented by the general formula (b) is denoted by monomer (b). CₘF₂ₘ₊₁ shown in the general formula (a) may have a linear chain or a branched chain. m represents an integer of 2 to 14, preferably an integer of 4 to 12. The content of CₘF₂ₘ₊₁ is preferably 20 to 70% by mass relative to the monomer (a), particularly preferably 40 to 60% by mass. R¹ represents hydrogen atom or methyl group. In addition, n represents 1 to 18, and among them, n is preferably 2 to 10. R² and R³ in the general formula (b) each independently represents hydrogen atom or methyl group, and R⁴ represents hydrogen atom or an alkyl group having 1 to 5 carbons. p and q represent an integer of 0 to 18, respectively, excluding the case where both of p and q are 0. p and q are preferably 2 to 8, respectively.

Furthermore, as monomer (a) used for forming one molecule of the copolymer, monomers having the same structures or monomers having different structures in the range defined above may be used. The same applies to monomer (b).

Weight-average-molecular weight Mw of the particularly preferable surfactant is preferably 1000 to 40000, more preferably 5000-20000. The surfactant is characterized by containing a copolymer: being formed of monomers represented by the general formula (a) and the general formula (b), respectively, and having a mass ratio of general formula (a)/general formula (b) of 20/80 to 60/40. One hundred parts by mass of the particularly preferable surfactant is formed of preferably 20 to 60 parts by mass of monomer (a), 80 to 40 parts by mass of monomer (b), and residual parts by mass of an arbitrary monomer, and is formed of more preferably 25 to 60 parts by mass of monomer (a), 60 to 40 parts by mass of monomer (b), and residual parts by mass of an arbitrary monomer.

Examples of copolymerizable monomers other than monomers (a) and (b) include styrene, derivatives thereof and substituted bodies thereof such as styrene, vinyl toluene, α-methylstyrene, 2-methylstyrene, chlorostyrene, vinylbenzoic acid, sodium vinylbenzene sulfonate and aminostyrene; dienes such as butadiene and isoprene; vinyl-based monomers such as acrylonitrile, vinyl ethers, methacrylic acid, acrylic acid, itaconic acid, crotonic acid, maleic acid, partially esterified maleic acid, styrene sulfonic acid, maleic anhydride, cinnamic acid, vinyl chloride and vinyl acetate and the like.

The particularly preferable surfactant is a copolymer of monomer (a), monomer (b) or the like, and the monomer sequence thereof is not particularly limited and may be random or regular, for example, may be a block or graft one. Furthermore, the particularly preferable surfactant can be used by mixing two or more kinds having different molecular structures and/or monomer compositions.

The content of the surfactant is preferably 0.01 to 10% by mass, particularly preferably 0.1 to 7% by mass relative to the total solid content of the photosensitive resin layer. The surfactant is one containing, in a prescribed amount, a surfactant having a specific structure and an ethylene oxide group and a polypropylene oxide group, and by containing the surfactant in the photosensitive resin layer in a specific range, display unevenness of a liquid crystal display device provided with the photosensitive resin layer is improved. When the content is less than 0.01% by mass relative to the total solid content, display unevenness is not improved, and when the content exceeds 10% by mass, the effect of improving the display unevenness appears insufficiently. The incorporation of the particularly preferable surfactant in the photosensitive resin layer is preferable in that the display unevenness is improved.

Preferable specific examples of fluorine-containing surfactants include compounds described in Japanese Patent Application Laid-Open No. 2004-163610, paragraph Nos. [0054] to [0063]. Furthermore, commercially available surfactants described below may also be used as they are. Examples of commercially available surfactants that are usable can include fluorine-containing surfactants such as Eftop EF301 and EF303 (manufactured by Shin Akita Kasei), Fluorad FC430 and 431 (manufactured by Sumitomo 3M Ltd.), Megafac F171, F173, F176, F189, F410, F444, F430, F477, F552, F553, F554, F555, F556, F557, F558, F559, F561, F562, R08, R40 and R41 (manufactured by Dainippon Ink And Chemicals, Incorporated), and Surflon S-382, SC101, 102, 103, 104, 105 and 106 (manufactured by Asahi Glass Co., Ltd.), and silicon-based surfactants. Furthermore, polysiloxane polymer KP-341 (manufactured by Shin-Etsu Chemical Co., Ltd.) and Troysol S-366 (manufactured by Troy Chemical Corporation) can also be used as a silicon-based surfactant. In the present invention, compounds described in Japanese Patent Application Laid-Open No. 2004-331812, paragraph Nos. [0046] to [0052], which are fluorine-containing surfactants formed of monomers not containing the monomer represented by the general formula (a), are also preferably used.

### [Support]

A support is not particularly limited, and a rigid one and a flexible one are useable, but a flexible one is preferable. The rigid support is not particularly limited, and includes well-known glass plates such as a soda glass plate having a silicon oxide coating film on the surface, a low-expansion glass plate, an alkali-free glass plate and a quartz glass plate; metal plates such as an aluminum plate, an iron plate and a SUS plate; a resin plate; a ceramic plate; a stone plate and the like. The flexible support is not particularly limited, and includes plastic films such as cellulose ester (such as cellulose acetate, cellulose propionate, cellulose butyrate), polyolefin (such as norbornene-based polymer), poly(meth)acrylic acid ester (such as polymethyl methacrylate), polycarbonate, polyester, polysulfone and norbornene-based polymer; paper; aluminum foil; cloth and the like. For ease of handling, the thickness of the rigid support is preferably 100 to 3000 μm, more preferably 300 to 1500 μm. The thickness of the flexible support is preferably 3 to 500 μm, more preferably 10 to 200 μm.

### [Alignment Layer]

The laminate film may have an alignment layer. The alignment layer functions so as to define the alignment direction of the liquid crystalline compound in the layer provided thereon. The alignment layer may be any layer as long as it can give alignment properties to the optically-anisotoropic layer. Preferable examples thereof can include a layer of an organic compound (preferably a polymer) having been subjected to a rubbing treatment; a photo alignment layer that shows alignment properties of a liquid crystal by irradiation with polarized light represented by azobenzene polymer and polyvinyl cinnamate; an oblique vapor deposition layer of an inorganic compound; and a layer having microgrooves; furthermore, a built-up film of ω-tricosanoic acid, dioctadecylmethylammonium chloride, methyl stearylate or the like which are formed by a Langmuir-Blodgett method (LB film); or a layer in which a dielectric material has been aligned by giving an electric field or a magnetic field. As the alignment layer, polyvinyl alcohol is preferably contained in a mode of rubbing, and, particularly preferably, the alignment layer can be cross-linked with at least either one of an upper layer or a lower layer thereof. A photo alignment layer and microgrooves are preferable as a method for controlling an alignment direction. As the photo alignment layer, one that can show alignment properties by dimerization such as polyvinyl cinnamate is particularly preferable, and as the microgroove, an emboss treatment with a master roll manufactured previously by mechanical processing or laser processing is particularly preferable.

### [Coating Method]

Compositions for producing each of the optically-anisotoropic layer, the polymer layer, the alignment layer and the like can be applied by a dip coating method, an air knife coating method, a spin coating method, a slit coating method, a curtain coating method, a roller coating method, a wire bar coating method, a gravure coating method or an extrusion coating method (U.S. Pat. No. 2,681,294). Two or more layers may be applied simultaneously. A method of simultaneous coating is described in U.S. Pat. Nos. 2,761,791, 2,941,898, 3,508,947 and 3,526,528; and Yuji Harazaki, “Coating Engineering,” p 253, Asakura Publishing Co., Ltd. (1973).

### EXAMPLES

Hereinafter, the present invention will be explained further more specifically while citing Examples. Materials, agents, amounts of substances and the ratio thereof, operations and the like shown in Examples below can appropriately be modified as long as the modification does not depart from the gist of the present invention. Accordingly, the scope of the present invention is not limited to specific examples below.

### Example 1

### Preparation of Liquid T-1 for Thermal Analysis Measurement

A composition described below was prepared and used as a liquid T-1 for thermal analysis measurement.

### Composition of Coating Liquid for Thermal Analysis Measurement (% by Mass)

| | |
|---|---|
| Polymerizable liquid crystal compound (LC-1-1) | 0.90 |
| Polymer | 1.00 |
| (Dianal BR605, manufactured by Mitsubishi Rayon Co., Ltd.) | |
| Methyl ethyl ketone | 88.29 |
| Methanol | 9.81 |

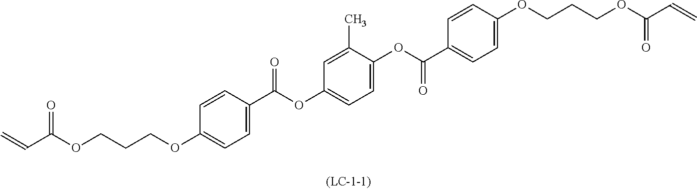 [SMILES: C=CC(=O)OCCCOc1ccc(C(=O)Oc2ccc(OC(=O)c3ccc(OCCCOC(=O)C=C)cc3)c(C)c2)cc1]

LC1-1 is solid at room temperature.

### (Preparation of Liquid T-2 for Thermal Analysis Measurement)

A composition described below was prepared and used as a liquid T-2 for thermal analysis measurement.

### Composition of Coating Liquid for Thermal Analysis Measurement (% by Mass)

| | |
|---|---|
| Polymerizable liquid crystal compound (LC-1-1) | 0.14 |
| Polymerizable liquid crystal compound (LC-1-2) | 0.77 |
| Polymer | 1.00 |
| (Dianal BR605, manufactured by Mitsubishi Rayon Co., Ltd.) | |
| Methyl ethyl ketone | 88.29 |
| Methanol | 9.81 |

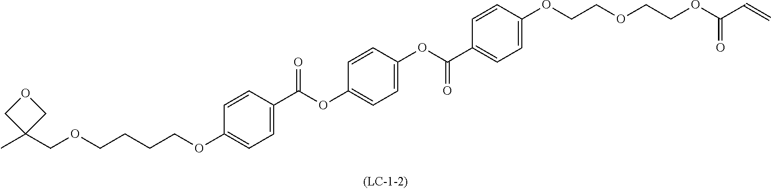 [SMILES: C=CC(=O)OCCOCCOc1ccc(C(=O)Oc2ccc(OC(=O)c3ccc(OCCCCOCC4(C)COC4)cc3)cc2)cc1]

LC-1-2 is solid at room temperature.

### (Thermal Analysis Measurement)

Each of liquids T-1 and T-2 for thermal analysis measurement, which was weighed in an amount of 50 μL, was injected into an aluminum pan for thermal analysis. The aluminum pan was left to stand at 25° C. for 12 hours in a vacuum dryer and drying was carried out. The aluminum pan was taken out of the vacuum dryer, and DSC measurement was performed. The DSC measurement was performed under conditions of temperature-rising of 25° C. to 135° C. and temperature-lowering of 135° C. to 0° C. Scanning rate was 5° C./min. Evaluation of the heat of crystallization observed in the temperature-lowering process gives 0.60 J/g and 0.15 J/g, respectively.

### (Preparation of Coating Liquid AL-1 for Alignment Layer)

A composition described below was prepared, which was filtrated with a polypropylene filter having a pore diameter of 30 μm and used as a coating liquid AL-1 for an alignment layer.

### Composition of Coating Liquid for Alignment Layer (% by Mass)

| | |
|---|---|
| Polyvinyl alcohol | 0.50 |
| Distilled water | 59.70 |
| Methanol | 39.80 |

### (Preparation of Coating Liquid LC-1 for Optically-Anisotoropic Layer)

A composition described below was prepared, which was then filtrated with a polypropylene filter having a pore diameter of 0.45 μm and used as a coating liquid LC-1 for an optically-anisotoropic layer.

### Composition of Coating Liquid for Optically-Anisotoropic Layer (% by Mass)

| | |
|---|---|
| Liquid crystalline compound having a | 32.88 |
| polymerizable group (LC-1-1) | |
| Horizontal alignment agent | 0.05 |
| (Megafac F-554, manufactured by Dainippon | |
| Ink And Chemicals, Incorporated) | |
| Radical polymerization initiator | 0.66 |
| (Irgacure 907, manufactured by Ciba | |
| Specialty Chemicals Corporation) | |
| Polymerization controlling agent | 0.07 |
| (lrganox 1076, Ciba Specialty Chemicals Corporation) | |
| Methyl ethyl ketone | 46.34 |
| Cyclohexanone | 20.00 |

### (Preparation of Coating Liquid LC-2 for Optically-Anisotoropic Layer)

A composition described below was prepared, which was then filtrated with a polypropylene filter having a pore diameter of 0.45 win and used as a coating liquid LC-2 for an optically-anisotoropic layer.

### Composition of Coating Liquid for Optically-Anisotoropic Layer (% by Mass)

| | |
|---|---|
| Liquid crystalline compound having a polymerizable | 4.93 |
| group (LC-1-1) | |
| Liquid crystalline compound having a polymerizable | 27.95 |
| group (LC-1-2) | |
| Horizontal alignment agent | 0.05 |
| (Megafac F-554, manufactured by Dainippon | |
| Ink And Chemicals, Incorporated) | |
| Radical polymerization initiator | 0.66 |
| (Irgacure 907, Ciba Specialty Chemicals Corporation) | |
| Polymerization controlling agent | 0.07 |
| (Irganox 1076, Ciba Specialty Chemicals Corporation) | |
| Methyl ethyl ketone | 46.34 |
| Cyclohexanone | 20.00 |

### (Preparation of Coating Liquid P-1 for Polymer Layer)

A composition described below was prepared, which was then filtrated with a polypropylene filter having a pore diameter of 0.45 μm and used as a coating liquid P-1 for a polymer layer.

### Composition of Coating Liquid for Polymer Layer (% by Mass)

| | |
|---|---|
| Polymer | 8.00 |
| (Dianal BR605, manufactured by Mitsubishi | |
| Rayon Co., Ltd.) | |
| Surfactant | 0.03 |
| (Megafac F-176PF, manufactured by Dainippon | |
| Ink And Chemicals, Incorporated) | |
| Methyl ethyl ketone | 82.77 |
| Methanol | 9.20 |

### (Production of Laminate Film A-1)

An alignment layer was formed by applying the coating liquid AL-1 for alignment layer using a wire bar, on a surface of a TAC film having a thickness of 50 μm, and then by drying the resultant substance. The dry thickness of the alignment layer was 0.1 μm. Subsequently, after subjecting the alignment layer to a rubbing treatment, the coating liquid LC-1 for an optically-anisotoropic layer was applied using a wire bar, which was dried at a surface temperature of 90° C. for 2 minutes, and the resultant layer was put into a liquid crystal phase state, and then, irradiation with ultraviolet rays was performed under the air by using an air-cooling metal halide lamp of 160 W/cm (manufactured by EYE GRAPHICS CO., LTD.) to thereby fix the alignment state and form an optically-anisotoropic layer having a thickness of 4.5 μm. The luminous intensity of ultraviolet rays used at this time was 600 mW/cm² in the UV-A region (integration between wavelengths of 320 nm-400 nm), and irradiation amount was 300 mJ/cm² in the UV-A region. The optically-anisotoropic layer exhibited retardation of 400 nm, and was solid polymer at 20° C. Finally, the coating liquid P-1 for a polymer layer was applied on the optically-anisotoropic layer by using a wire bar, which was then dried to form a polymer layer having a thickness of 0.8 μm. A laminate film A-1 was thus produced.

### (Production of Laminate Film A-2)

A laminate film A-2 was produced in a similar manner to that of A-1 except for using LC-2 as the coating liquid for an optically-anisotoropic layer.

### (Measurement of Liquid Crystalline Compound Content in Polymer Layer)

The polymer and the liquid crystalline compound were mixed with KBr, IR measurement was performed, and calibration curves of the polymer and the liquid crystalline compound were prepared. The polymer layer was scraped off by cutting-off of surfaces of the laminate films A-1 and A-2 with a cutter knife. Mixing of the polymer layer having been scraped off, with potassium bromide gave a KBr tablet. Using the KBr tablet, IR measurement was performed, and the content of the liquid crystal composition in the polymer layer was determined by using the calibration curve. The contents of the liquid crystalline compound in A-1 and A-2 were 3.0% by mass and 19.6% by mass, respectively.

### (Evaluation of Precipitation Properties)

Weight of 2 kg/cm² was applied to laminate films A-1 and A-2 at 40° C., and the resultant films were left to stand for 24 hours. After that, the surface condition thereof was checked and crystal precipitation was not recognized in both cases of the films A-1 and A-2.

### Comparative Example 1

### Preparation of Liquid T-3 for Thermal Analysis Measurement

A composition described below was prepared, which was filtrated with a polypropylene filter having a pore diameter of 30 μm and used as a coating liquid T-3 for thermal analysis measurement.

### Composition of Coating Liquid for Thermal Analysis Measurement (% by Mass)

| | |
|---|---|
| Polymerizable liquid crystal compound (LC-1-1) | 0.90 |
| Polymer | 0.10 |
| (CYCLOMER ACA Z-300, manufactured by | |
| Daicel-Cytec Company Ltd.) | |
| Methyl ethyl ketone | 88.29 |
| Methanol | 9.81 |

### (Preparation of Liquid T-4 for Thermal Analysis Measurement)

A composition described below was prepared, which was filtrated with a polypropylene filter having a pore diameter of 30 μm and used as a coating liquid T-4 for thermal analysis measurement.

### Composition of Coating Liquid for Thermal Analysis Measurement (% by Mass)

| | |
|---|---|
| Polymerizable liquid crystal compound (LC-1-1) | 0.14 |
| Polymerizable liquid crystal compound (LC-1-2) | 0.77 |
| Polymer | 0.10 |
| (CYCLOMER ACA Z-300, manufactured by | |
| Daicel-Cytec Company Ltd.) | |
| Methyl ethyl ketone | 88.29 |
| Methanol | 9.81 |

### (Thermal Analysis Measurement)

Evaluation of the heat of crystallization of T-3 and T-4, in the same manner as for T-1 and T-2, gives 1.88 J/g and 0.80 J/g, respectively.

### (Evaluation of Precipitation Properties)

### (Preparation of Coating Liquid P-2 for Polymer Layer)

A composition described below was prepared and used as a coating liquid P-2 for a polymer layer.

### Composition of Coating Liquid for Polymer Layer (% by Mass)

| | |
|---|---|
| Polymer | 8.00 |
| (CYCLOMER ACA Z-300, manufactured by | |
| Daicel-Cytec Company Ltd.) | |
| Surfactant | 0.03 |
| (Megafac F-176PF, manufactured by Dainippon | |
| Ink And Chemicals, Incorporated) | |
| Methyl ethyl ketone | 82.77 |
| Methanol | 9.20 |

A laminate film A-3 and A-4 were produced in a similar manner to that of the laminate film A-1 and A-2 in Example 1, respectively, except for using P-2 as the coating liquid for a polymer. Weight of 2 kg/cm² was applied to polymer films A-3 and A-4 at 40° C., and the resultant films were left to stand for 24 hours. After that, the surface condition thereof was checked and intense crystal precipitation was recognized.

### (Measurement of Liquid Crystalline Compound Content in Polymer Layer)

Surfaces of the laminate films A-3 and A-4 were cut off with a cutter knife, and the content of the liquid crystal composition in the polymer layers were determined in the same manner as that in Example 1. The contents of the liquid crystalline compound in A-3 and A-4 were 2.6% by mass and 18.5% by mass, respectively.

It has been confirmed that, when a crystallization heat is 0.75 J/g or less, crystal precipitation is not generated and the laminate film can be stored, whereas, when a crystallization heat is above 0.75 J/g, the laminate film cannot be stored due to considerable crystal precipitation.

While the present invention has been described in detail and with reference to specific embodiments thereof, it will be apparent to one skilled in the art that various changes and modifications can be made therein without departing from the spirit and scope thereof. All the publications referred to in the present specification are expressly incorporated herein by reference in their entirety. The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A method for producing a laminate film comprising forming a layer by curing a liquid crystalline composition containing a liquid crystalline compound that has a polymerizable group and is solid at 25° C. and forming, on the layer, a polymer layer from a composition containing a polymer, the liquid crystalline compound migrating into the polymer layer after forming the polymer layer until the compound becomes 0.1% by mass to 30% by mass relative to the solid content mass of the polymer layer, wherein the method includes selecting the liquid crystalline compound and the polymer from combinations having a heat of crystallization of a mixture obtained by mixing the two at a mass ratio of 9:10, of 0.75 J/g or less.

2. The production method according to claim 1, comprising obtaining the heat of crystallization of the mixture.

3. The production method according to claim 1, comprising obtaining the heat of crystallization of the mixture by using differential scanning calorimetry.

4. The production method according to claim 2, comprising obtaining the mixture by mixing the liquid crystalline compound and the polymer at a mass ratio of 9:10.

5. The production method according to claim 3, comprising obtaining the mixture by mixing the liquid crystalline compound and the polymer at a mass ratio of 9:10.

6. The production method according to claim 4, comprising obtaining the mixture by dissolving the liquid crystalline compound and the polymer in a solvent, and drying the obtained solution.

7. The production method according to claim 5, comprising obtaining the mixture by dissolving the liquid crystalline compound and the polymer in a solvent, and drying the obtained solution.

8. The production method according to claim 6, wherein the solvent comprises methylethylketone.

9. The production method according to claim 1, wherein the composition containing a polymer is applied directly on a layer formed by curing the liquid crystalline composition.

10. The production method according to claim 1, wherein the liquid crystalline compound migrates into the polymer layer after forming the polymer layer until the compound becomes 1% by mass to 20% by mass relative to the solid content mass of the polymer layer.

11. The production method according to claim 1, wherein the curing is performed by a polymerization reaction by light irradiation.

12. The production method according to claim 1, wherein the composition containing a polymer is applied as a solution of a solvent selected from an alkyl halide, an ester, a ketone, an alcohol, a glycol ether or a mixture thereof.

13. The production method according to claim 12, wherein the composition containing a polymer is applied as a solution of a solvent selected from acetone, methyl ethyl ketone, methyl isobutyl ketone, cyclohexanone, methanol, ethanol, isopropanol, butanol, propylene glycol monomethyl ether, dipropylene glycol monomethyl ether or a mixture thereof.

14. A laminate film produced by the production method according to claim 1.

15. A laminate film including a layer formed of a liquid crystalline composition containing a liquid crystalline compound having a polymerizable group and a polymer layer formed of a composition containing a polymer in this order, wherein the liquid crystalline compound is contained in the polymer layer in an amount of 0.1% by mass to 30% by mass relative to solid content mass of the polymer layer; the liquid crystalline compound is a compound that is solid at 25° C.; and heat of crystallization of a mixture obtained by mixing the liquid crystalline compound and the polymer at a mass ratio of 9:10 is 0.75 J/g or less.

16. The laminate film according to claim 15 wherein the polymer layer is an optically isotropic layer.

17. The laminate film according to claim 15, wherein the liquid crystalline compound is a rod-like liquid crystalline compound having two polymerizable groups; and the polymer is polymethyl (meth)acrylate, a copolymer of (meth)acrylic acid and (meth)acrylic acid ester, polyester, polyurethane, polystyrene, polyvinyl alcohol, ethylene-vinyl acetate copolymer, polyvinyl chloride or a cellulose derivative.

18. The laminate film according to claim 15, wherein the polymer has a polar group or a hydrophilic group on a side chain.

19. The laminate film according to claim 18, wherein the polar group or the hydrophilic group is hydroxyl group or carboxyl group.

20. The laminate film according to claim 15, wherein thickness of the polymer layer is 10 μm or less.
